(19) United States
(12) Patent Application Publication
(10) Pub. No.: US 2009/0154016 A1
(43) Pub. Date: Jun. 18, 2009

(54) Computer storage drive with user selectable mode of identification

(76) Inventor: Marc Jacques Lalouette, Boulder, CO (US)

Correspondence Address: Marc Lalouette, 3344 16th Street, Boulder, CO, 80304, US

(21) Appl. No.: 12/002,400

(22) Filed: Dec. 17, 2007

(51) Int. Cl. G11B 23/03

(52) U.S. Cl. 360/133

(57) ABSTRACT

A computer drive bay that accepts hard drive cartridges and has the ability for the user to select between identifying itself to the host computer as either a-removable media device or as a fixed disc to improve data backup operations.

This application is being filed as a non-provisional patent application.

### FIELD OF THE INVENTION

This invention relates to the field of generally removable disc drives, also referred to as disc drive cartridges, and the means they identify themselves to their host systems.

### BACKGROUND OF THE INVENTION

A removable disc drive cartridge is a type of removable media that is employed to store and to physically transport data between two different locations. Typically, a disc drive cartridge transports data between two different computers that are each located at different locations, or is used for offsite backup for disaster recovery purposes. Other types of removable media, such as compact discs (CD), digital video discs (DVD), tape cartridges or flash memory keys can also be used to physically transport data between two different computers.

Patents and patent publications that relate to the general subject matter of removable disc drive cartridges include U.S. Pat. No. 4,941,841 to Darden, U.S. Pat. No. 5,837,934 to Valavanis, U.S. Pat. No. 6,154,360 to Kaczeus, and U.S. 2005/0257949 to Lalouette.

These disc drive cartridges are inserted into drive bays that either reside inside a main chassis of, for example, a personal computer, a media center, or a server rack; or the drive bay may reside on the desktop as a stand-alone external drive. This invention primarily pertains to drive bays that reside inside a main chassis or server rack, as opposed to external drives that accept hard drive cartridges. Differences between existing desktop internal drives that accept hard drive cartridges and the subject of this invention are detailed herein.

### SUMMARY OF THE INVENTION

The invention provides a drive which accepts a cartridge and has the means for the user to select between two distinct modes of operations, both of which have relative advantages and disadvantages.

In the first of these modes of operation in the present invention, the drive presents itself to the host as a removable media device. By presenting itself to the host in this manner, it facilitates the ‘hot plug’ mounting and removal of the hard drive cartridge. This mode of operation has the advantage of controlling the hot plug behavior in systems where the host bus is not configured by the BIOS to support hot plugging and removal of disc drives. In those systems typically the host polls the bus to investigate what devices are attached. If no device is present, the port is often disabled, so that a device that is subsequently plugged in will not be identified by the host system until it is power cycled. The disadvantage to the removable media device mode of operation is that many operating systems will not allow straightforward ‘boot up’ from removable media devices. This is done in order to prevent use of an unauthorized copy of the operating system.

In the second mode of operation of the present invention, the drive identifies itself to the host simply as a fixed disc if a cartridge is inserted into the drive. If a cartridge is not inserted into the drive, the drive will not identify itself, so that the drive does not present itself to the host computer, appearing to the host computer that nothing is plugged into that port. This mode of operation has the advantage of allowing most operating systems to boot directly from the cartridge when it is in place in the drive. This is useful in backup situations, and removes the necessity to have a separate system recovery disc in addition to the hard drive cartridge as is required with devices that present themselves as removable media drives.

An envisioned application for this dual mode of operation is for computer backup operations. The removable media mode is used to back up the host computer's data onto the removable cartridge, which can then be removed and placed in safe storage, either on site or off site. In the event of a host computer hard drive failure, the user can then switch the mode of operation to have the drive identify itself as a fixed disc with a cartridge in place. This will allow the computer to boot normally from the cartridge, allowing the user to continue to operate his computer normally. The user can then replace the failed host hard drive at their convenience, and copy the operating system and all of the data from the cartridge onto the new host hard drive.

### BRIEF DESCRIPTION OF THE DRAWINGS

The objects and features of the invention can be better understood with reference to the claims and drawings described below. The drawings are not necessarily drawn to scale, and the emphasis is instead placed upon illustrating the principles of the invention. Within the drawings, like reference numbers are used to indicate like parts throughout the various views. Differences between like parts may cause those parts to be indicated by different reference numbers. Unlike parts are indicated by different reference numbers.

For a further understanding of these and objects of the invention, reference will be made to the following detailed description of the invention which is to be read in connection with the accompanying drawing, wherein:

FIG. 1 illustrates an exploded view of a removable disc drive cartridge.

FIG. 2 shows a drive bay 200 designed to accept a removable disc drive cartridge 100 and a personal computer or server chassis 201 with an open bay 202 that the drive bay 200 can be installed into.

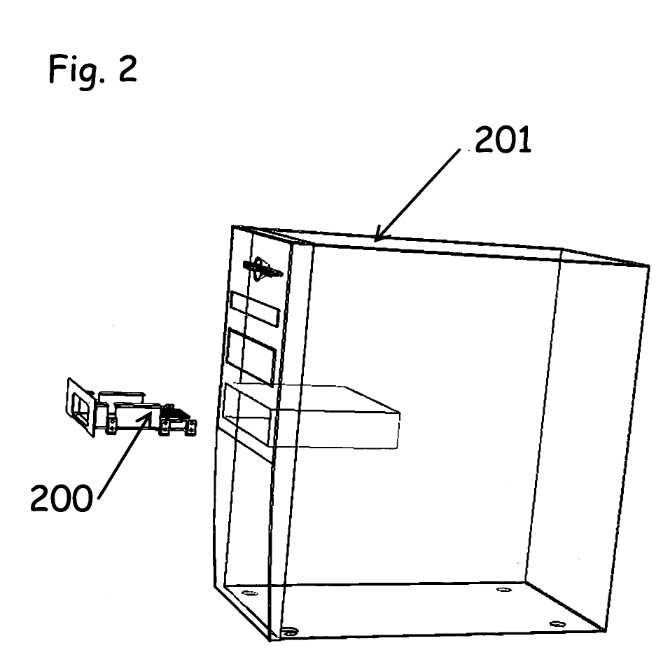

FIG. 3 illustrates a drive bay 200 for a hard drive cartridge 100 mounted into a PC chassis 201 with the hard drive cartridge 100 installed in the operating position.

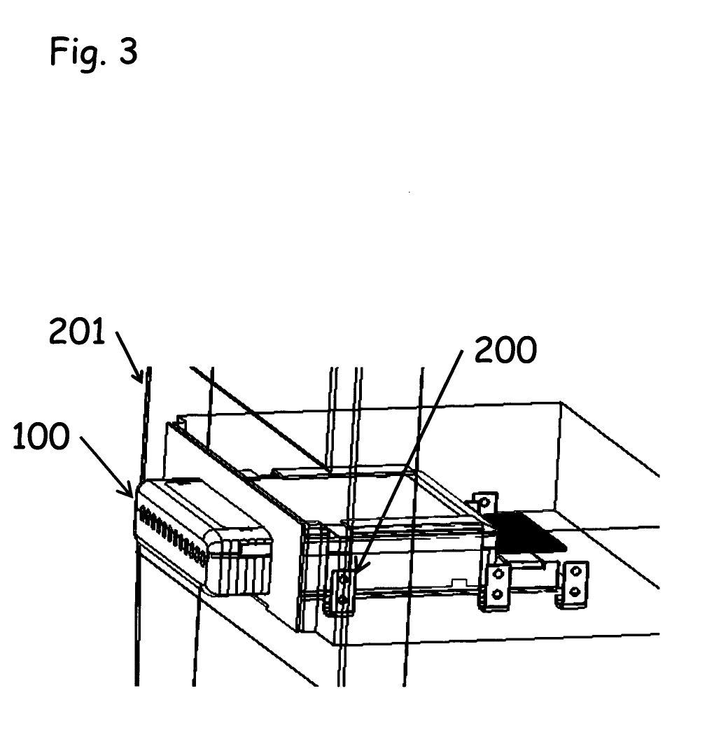

### DETAILED DESCRIPTION OF THE INVENTION

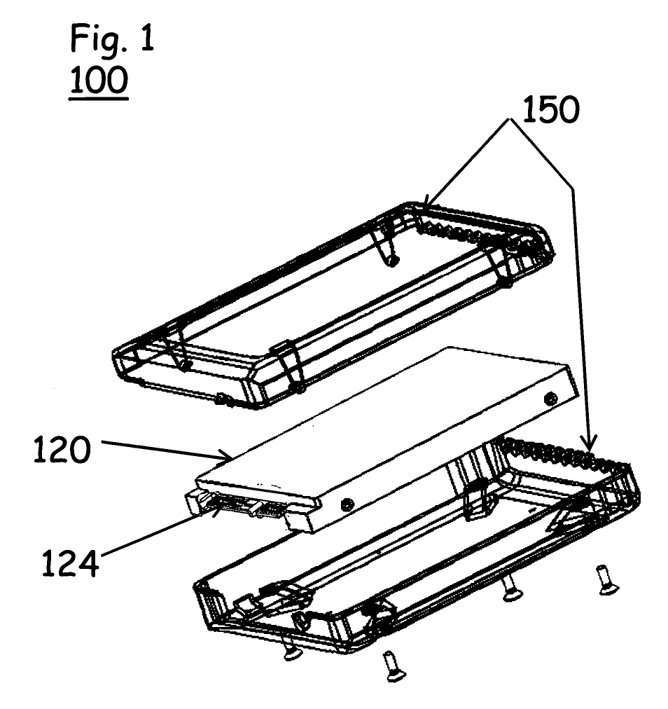

FIG. 1 illustrates an exploded view of a removable disc drive cartridge 100. As shown, the removable disc drive cartridge 100, also referred to as a cartridge 100, is comprised of an enclosure 150. The enclosure 150 is configured to surround and to protect a disc drive 120, and has an opening to provide access to a plurality of electrical connections 124 of a disc drive 120. The electronic connectors 124 are configured to electronically connect to a complementary set of electronic connectors provided within a drive bay 200 that mounts inside a personal computer or server chassis 201.

In the present implementation, the drive bay 200 is attached to the host computer via the serial ATA connection, although implementations with other interface types are possible. Serial ATA (SATA) is an interface standard that is defined by the T13 technical committee of accredited standards committee NCITS for the purpose of providing interoperability between different computer manufacturers hardware and software.

The SATA interface provides means for both fixed and removable devices. Both of these types of devices have advantages and disadvantages.

For removable devices the T13 committee created the Removable Media Status Notification and Removable Media Feature sets. The Removable Media Status Notification feature set is intended for use in both devices implementing the PACKET command feature set and those not implementing the PACKET command feature set. Second, the Removable Media feature set is intended for use only in devices not implementing the PACKET command feature set. Only one of these feature sets is enabled at any time. If the Removable Media Status Notification feature set is in use then the Removable Media feature set is disabled and vice versa. The reasons for implementing the Removable Media Status Notification feature Set of the Removable Media feature set are to prevent data loss caused by writing to new media while still referencing the previous media's information, to prevent data loss by locking the media until completion of a cached write and to prevent removal of the media by unauthorized persons.

Certain computer operating systems do not allow themselves to be easily copied onto devices that identify themselves as removable media. One reason for this is to prevent unauthorized copy or software piracy. While the means exist to copy them completely onto removable media such as a low level sector by sector copy, some operating systems do not allow boot up operation when the device they are resident on self reports as removable media across the interface to the host computer. Examples of operating systems that have this difficult booting behavior are Windows XP and Windows Server.

In the case of backup operations, it is desirable for the backup copy of the host system 201 to be fully bootable such that the host system 201 operation can be resumed and the data recovered immediately without having to perform multiple operations. To achieve this behavior, it is sometimes necessary that the removable hard drive cartridge 100 installed into a drive bay 200 reports to the host 201 as a fixed disc. This behavior can be described as a pass through mode for the drive bay 200, where the drive bay 200 simply passes through the electrical connections between the cartridge 100 and the host system 201.

The advantages to the user of having the drive bay 200 report as removable media is that many host computers do not provide hot plug support for all of their ports. In particular, many host computers 201 do not provide hot plug support for their SATA ports. A typical scenario is that the host computer 201 will poll all of the SATA ports upon power up to detect the presence of a SATA device that is connected to the specific ports. If no device is detected, then in many cases the port will be deactivated. In the case of a removable hard drive cartridge 100, if this is subsequently plugged into a drive bay 200 that provides a direct connection to a SATA port after the power up operation is complete, in systems 201 without hot plug support that drive will not be detected. If the hard drive cartridge 100 is plugged into the drive bay 200 at the time of initial power up of the host system 201, and then subsequently removed, a host system 201 operating system that does not have hot plug support for the connection to the drive bay 200 may have problems or crash.

To allow the drive bay 200 to have both of these desirable properties, the present invention consists of providing a means for the user to toggle between these two modes by either a switch or electrical jumper. It is envisioned that the user will use the removable media mode for day to day use, which will allow a host computer 201 without hot plug support for a SATA connection to recognize the insertion and removal of a hard drive cartridge 100 into the drive bay 200 correctly.

In the event of a host computer 201 hard drive crash, the user may then select the second mode of operation, providing for direct connection or pass through recognition of the hard drive cartridge 100 to the host system 201 as a fixed device. This will facilitate the booting of the operating system and allow the user to operate his computer normally, after which he can replace the failed drive at his convenience.

While the present invention has been particularly shown and described with reference to the preferred mode as illustrated in the drawing, it will be understood by one skilled in the art that various changes in detail may be effected therein without departing from the spirit and scope of the invention as defined by the claims.

We claim:

1. A computer drive bay where the mode of operation by which it reports to the host computer is user configurable to be identified as either a removable media device or as a direct connect fixed disc memory device.

2. The computer drive bay of claim 1, where the means to select the mode of operation is a switch.

3. The computer drive bay of claim 1, where the means to select the mode of operation is a jumper.

4. The computer drive bay of claim 1, where the means to select the mode of operation is mounted on the front panel of the drive bay.

5. The computer drive bay of claim 3, where the location of the jumper mounting is on the front panel of the drive bay.

6. The computer drive bay of claim 1 where the means to identify is a separate connection to the drive.
